(19) United States
(12) Patent Application Publication
(10) Pub. No.: US 2012/0129668 A1
(43) Pub. Date: May 24, 2012

(54) PAINT ROLLER COVER SUPPORT APPARATUS

(75) Inventors: Charles T. Buckel, JR., Valley City, OH (US); Michael C. Lambertson, JR., Aurora, OH (US); Sara-Jane A. Anderson, Chesterland, OH (US)

(73) Assignee: THE SHERWIN-WILLIAMS COMPANY, Cleveland, OH (US)

(21) Appl. No.: 13/167,830

(22) Filed: Jun. 24, 2011

Related U.S. Application Data
(60) Provisional application No. 61/358,719, filed on Jun. 25, 2010.

(51) Int. Cl. F16C 13/00

(52) U.S. Cl. 492/47

(57) ABSTRACT

A paint roller support may include a core support assembly suitable to receive a paint roller cover. The core support assembly may include a mid-portion having a shape that improves the performance of the core support assembly.

This application claims priority to U.S. Ser. No. 61/358,719, entitled PAINT ROLLER SUPPORT APPARATUS, filed Jun. 25, 2010, which is incorporated herein by reference.

### BACKGROUND OF THE INVENTION

A. Field of Invention

This invention pertains to methods and apparatuses for paint roller supports used to support paint roller covers in the application of paint or other coatings to surfaces. More specifically this invention pertains to paint roller supports which operatively hold and retain paint roller covers and operatively attach them to paint roller handles.

B. Description of the Related Art

It is well known in the art to use paint rollers to apply paint or other surface treatments to various surfaces. It is also well known to provide paint roller supports that permit the removal of the roller cover for replacement or cleaning. A problem in the art is in order to allow for removal of the roller cover, the roller cover is not permanently fixed to the roller support and during use the roller cover tends to work its way off the support.

It is known in the art to provide paint roller supports with bearings which allow the roller core support and cover to rotate relative to the paint roller frame. A disadvantage of such paint rollers can be paint or other foreign objects reaching the bearings and interfering with their bearing function.

Known attempted solutions to the roller cover coming off the paint roller support include increasing the friction fit between the cover and the roller support. This method has the inherit disadvantage of making the roller cover more difficult to put onto or remove from the roller support. Another attempted solution is to have a core support with a complex surface geometry that grips the roller cover in an improved manner. This method often results in additional cost to the paint roller. Known attempted solutions to foreign matter fouling the bearings include encapsulating the bearings in subassemblies that are then secured to the roller support. Once again, this method often results in additional cost to the paint roller.

What is needed is an inexpensive, easy to assembly, and durable paint roller support.

### SUMMARY OF THE INVENTION

According to one embodiment of this invention, a paint roller support may comprise: a frame; a shaft having a proximal end connected to the frame and a distal free end; a bearing element that is received over the shaft and that comprises a proximal end portion and a distal end portion; and, a core support assembly suitable to receive an associated paint roller cover having a proximal end and a distal end. The core support assembly may comprise: a proximal bushing that is received over the proximal end portion of the bearing element and that has an outer surface suitable to contact an inner surface of the proximal end of the associated paint roller cover to support the associated paint roller cover to the core support assembly; a distal bushing that is received over the distal end portion of the bearing element and that has an outer surface suitable to contact an inner surface of the distal end of the associated paint roller cover to support the associated paint roller cover to the core support assembly; and, a mid-portion comprising: a proximal end that contacts the proximal bushing and that has a frustoconical shape; a distal end that contacts the distal bushing and that has a frustoconical shape; and, a middle portion having a cylindrical shape with a substantially constant outer diameter.

According to another embodiment of this invention, a paint roller support may comprise: a frame; a shaft having a proximal end connected to the frame and a distal free end; a bearing element that is at least 3.0 inches long and that comprises a proximal end that is received over the proximal end of the shaft and a distal end that is received over the distal end of the shaft; and, a core support assembly suitable to receive an associated paint roller cover having a proximal end and a distal end. The core support assembly may comprise: a proximal bushing that is received over the proximal end of the bearing element and that has an outer surface suitable to contact an inner surface of the proximal end of the associated paint roller cover to support the associated paint roller cover to the core support assembly; a distal bushing that is received over the distal end of the bearing element and that has an outer surface suitable to contact an inner surface of the distal end of the associated paint roller cover to support the associated paint roller cover to the core support assembly; and, a mid-portion comprising: a proximal end that contacts the proximal bushing and; a distal end that contacts the distal bushing; and, a middle portion.

According to yet another embodiment of this invention, a paint roller support may comprise: a frame having a first end and a second end; a shaft having a proximal end connected to the first end of the frame and a distal free end; a core support assembly that is received over the shaft and that has an outer surface suitable to contact an inner surface of an associated paint roller cover to support the associated paint roller cover to the core support assembly; a handle having a first end that is attachable to the second end of the frame, the first end of the handle comprising a bucket hook having a length BL, a width BW, and a height BH; and, wherein a ratio of the length to the height BL/BH is at least 1.5.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is an exploded assembly view of a paint roller support according to one embodiment of this invention.

FIG. 2 is a perspective view of a paint roller cover.

FIG. 3 is a front view of a paint roller support.

FIG. 4 is a frontal sectional view of a portion of the paint roller support shown in FIG. 3.

FIG. 5 is a front view of the mid-portion shown in FIG. 1.

FIG. 6 is a sectional view of the mid-portion shown in FIG. 5.

FIG. 7 is a perspective view of the proximal bushing shown in FIG. 1.

FIG. 8 is a side view of the proximal bushing shown in FIG. 7.

FIG. 9 is a sectional view of the proximal bushing shown in FIG. 8.

FIG. 10 is a perspective view of the distal bushing shown in FIG. 1.

FIG. 11 is a side sectional view of the distal bushing shown in FIG. 10.

FIG. 12 is an exploded assembly view of a paint roller support according to another embodiment of this invention.

FIG. 13 is a front view of a paint roller support.

FIG. 14 is a frontal sectional view of a portion of the paint roller support shown in FIG. 13.

FIG. 15 is a front view of the mid-portion shown in FIG. 12.

FIG. 16 is a sectional view of the mid-portion shown in FIG. 15.

FIG. 17 is an exploded assembly view of a paint roller support according to yet another embodiment of this invention.

FIG. 18 is a front view of a portion of a paint roller support.

FIG. 19 is a frontal sectional view of the paint roller support shown in FIG. 18.

FIG. 20 is a perspective view of a bearing element shown in FIG. 17

FIG. 21 is a perspective view of the middle section and proximal bushing shown in FIG. 17.

FIG. 22 is a side view of the middle section and proximal bushing shown in FIG. 21.

FIG. 23 is a sectional view of the middle section and proximal bushing shown in FIG. 22.

FIG. 24 is a perspective view of the distal bushing shown in FIG. 21.

FIG. 25 is a side sectional view of the distal bushing shown in FIG. 24.

### DETAILED DESCRIPTION OF THE INVENTION

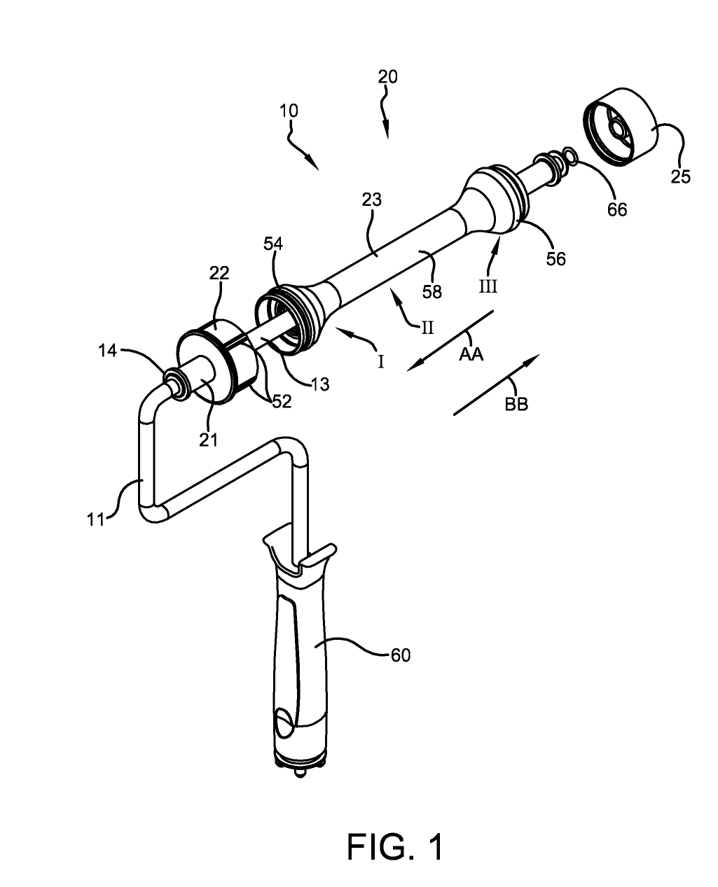

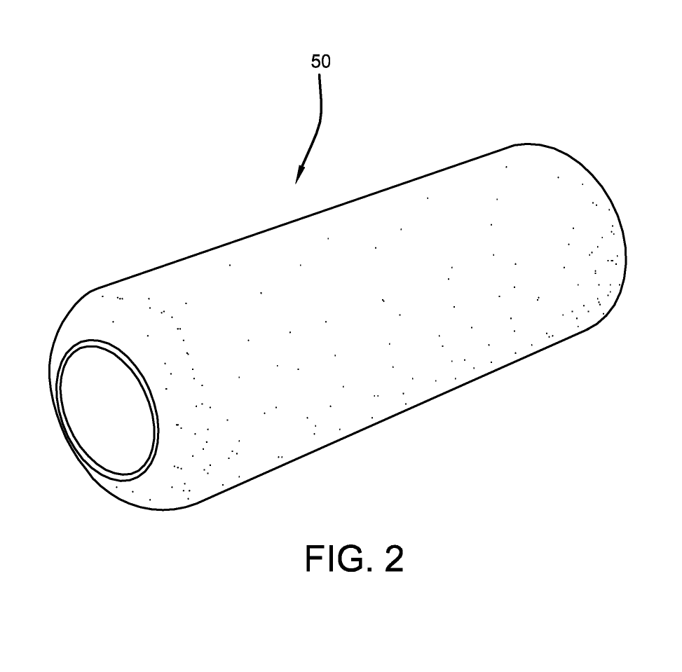

Referring now to the drawings wherein the showings are for purposes of illustrating embodiments of the invention only and not for purposes of limiting the same, and wherein like reference numerals are understood to refer to like components, FIG. 1 shows a paint roller support 10 that is used to support a roller cover 50 (see FIG. 2). The paint roller support 10 may include a frame 11 and a shaft 13 that extends from the frame 11. For purposes of describing relative orientation only, in this patent the word “proximal” will mean the direction toward the frame 11 (direction AA) and the word “distal” will mean the direction away from the frame 11 (direction BB). Thus, the shaft 13 shown has a proximal end connected to the frame 11 and a distal free end. The paint roller support 10 may also include a bearing element 21 and a core support assembly 20.

With reference to all the FIGURES, the core support assembly 20 may be suitable to receive a paint roller cover, such as roller cover 50, having a proximal end and a distal end. The core support assembly 20 may include a proximal bushing 22 that is received over the proximal end portion of the bearing element 21 and that has an outer surface suitable to contact an inner surface of the proximal end of the paint roller cover 50 to support the paint roller cover 50 to the core support assembly 20. The core support assembly 20 may also include a distal bushing 25 that is received over the distal end portion of the bearing element 21 and that has an outer surface suitable to contact an inner surface of the distal end of the paint roller cover 50 to support the paint roller cover 50 to the core support assembly 20. The core support assembly 20 may also include a mid-portion 23 having a proximal end 54 that contacts the proximal bushing 22, a distal end 56 that contacts the distal bushing 25 and a middle portion 58. Note that the proximal end 54 may have a frustoconical shape, the distal end may also have a frustoconical shape, and the middle portion 58 may have a cylindrical shape with a substantially constant outer diameter. This shape provides many advantages including: good attachment of the roller cover 50, easy detachment of the roller cover 50, and protection of bearing element 21 from paint.

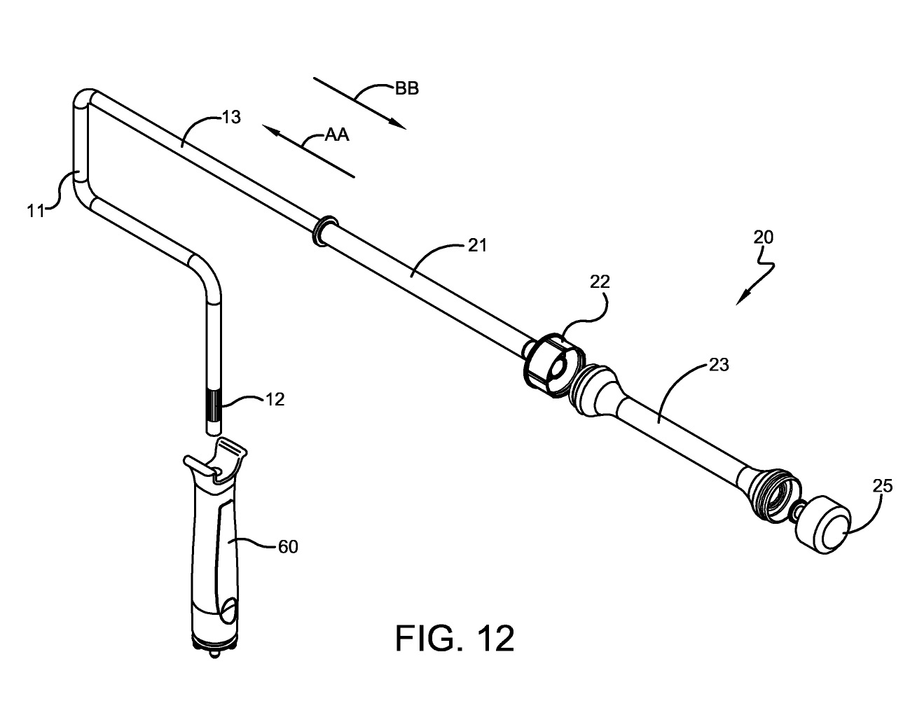

With reference to FIGS. 1-2, 12 and 17, the paint roller cover 50 may be forcibly slid over of the core support assembly 20. The resulting grip may be tight enough to prevent the roller cover 50 from working its way off the core support assembly 20 during use but also light enough so that the roller cover may be easily installed or removed for cleaning or disposal without the use of tools. The frame 11 may be bent to provide a handle mounting portion 12 at one end and provide the shaft 13 at the other end of the frame 11. The frame 11 may be formed from wire rod material. The frame 11 material may be chosen with the sound judgment of a person of skill in the art. In one embodiment, the frame 11 and shaft 13 is made of aluminum to reduce the weight of the paint roller support 10. In another embodiment, the frame 11 and shaft 13 may be made of steel. A rear washer 14 may be received over the proximal end of the shaft 13. The shaft 13 may have a protrusion formed on its outside surface at a fixed location. The shaft protrusion may be sized to prevent the rear washer 14 from traveling further along the shaft 13 thus fixing the location of the rear washer 14. The rear washer 14 may be formed from metal, plastic or any material chosen with the sound judgment of a person of skill in the art. A retaining clip 66 may be used on the distal end and used to hold component in place.

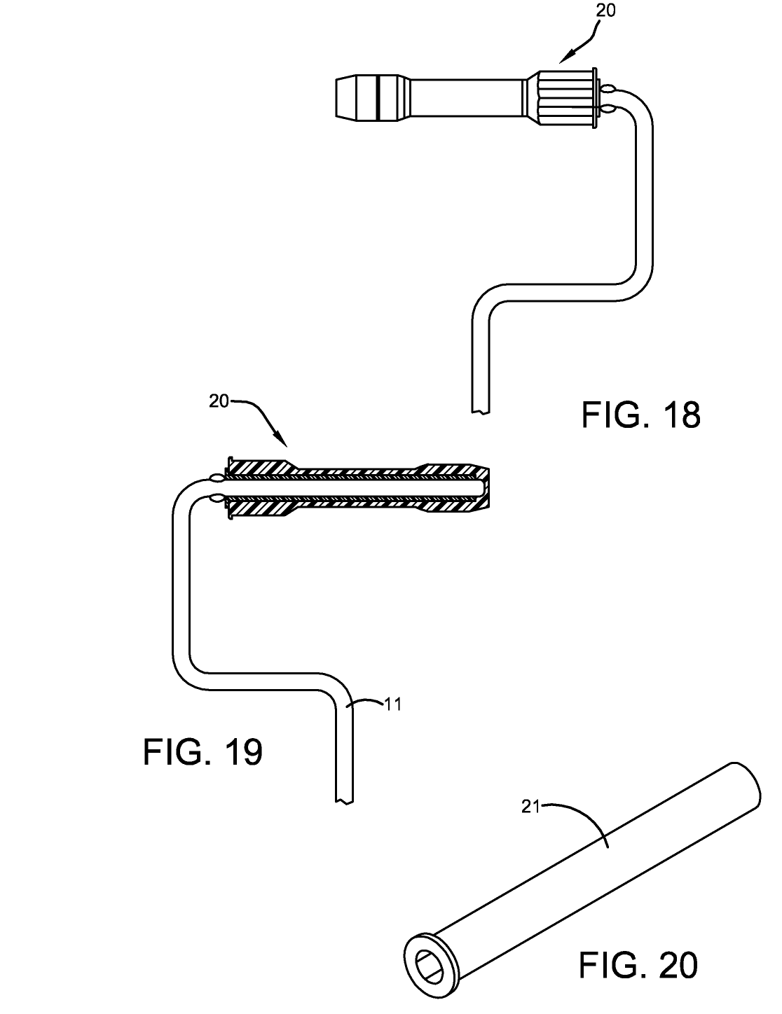

Referring to FIGS. 1-2, 4, 12, 14, 17 and 19-20, the inside diameter of the bearing element 21 and the outside diameter of the shaft 13 may be sized so that the bearing element 21 is free to rotate around the shaft 13. In another embodiment, the bearing element 21 bay be fixed to the shaft 13 and the core support assembly 20 may rotate around the bearing element 21. The bearing element's 21 axial position along the shaft 13 may be determined by interference with the rear washer 14. The bearing element 21 material may be metal, plastic or any material chosen with the sound judgment of a person of skill in the art. In one embodiment, the bearing element 21 comprises two separate pieces—one positioned on the proximal end of the shaft 13 and the other positioned on the distal end of the shaft 13. In another embodiment, shown, the bearing element 21 may be one piece. The bearing element 21 in one embodiment is at least 3.0 inches long. In another embodiment, the core support assembly 20 is less than 4.0 inches long. These two features combined provide for a relatively smaller paint roller support 10 suitable to support relatively smaller roller cover 50 sizes. Some non-limiting examples include 4½ inch roller covers and 6½ inch roller covers. In yet another embodiment, the bearing element may be least 8.0 inches long and the core support assembly 20 may be at least 8.0 inches long.

These two features combined provide for a relatively larger paint roller support 10 suitable to support relatively larger roller cover 50 sizes. A non-limiting example is a 9 inch roller cover. The proximal bushing 22 may be received over the bearing element 21. The proximal end of the proximal bushing 22 may be positioned so it aligns with the end of the bearing element 21 nearest the rear washer 14. The mid-portion 23 may be received over the bearing element 21.

The inside diameter of the mid-portion 23 and the outside diameter of the bearing element 21 may be sized so that the mid-portion 23, once installed over the bearing element 21, cannot move relative to the bearing element 21. In an alternate configuration, the inside diameter of the mid-portion 23 and the outside diameter of the bearing element 21 may be sized so that the mid-portion 23 slides easily over the bearing element with clearance between the two parts. The proximal bushing 22 and the mid-portion 23 may be formed so they mate in such a manner that the proximal bushing 22 and mid-portion 23 cannot move relative to each other. Alternately, the proximal bushing 22 and mid-portion 23 may be integrally formed. The front washer 24 may be received on the distal end of shaft 13 and its axial position determined by the position of the mid-portion 23. The distal bushing 25 may be received over the distal end of the shaft 13 in such a manner so as to be free to rotate about the shaft. The distal bushing 25 may be fixedly mated with the mid-portion 23. The distal bushing 25 and the mid-portion 23 may mate in a manner to seal the joint. This sealing feature prevents paint or foreign substances from reaching the bearing element 21. Alternately the distal bushing 25 may be integrally formed with the mid-portion 23 and the front washer 24 would be eliminated.

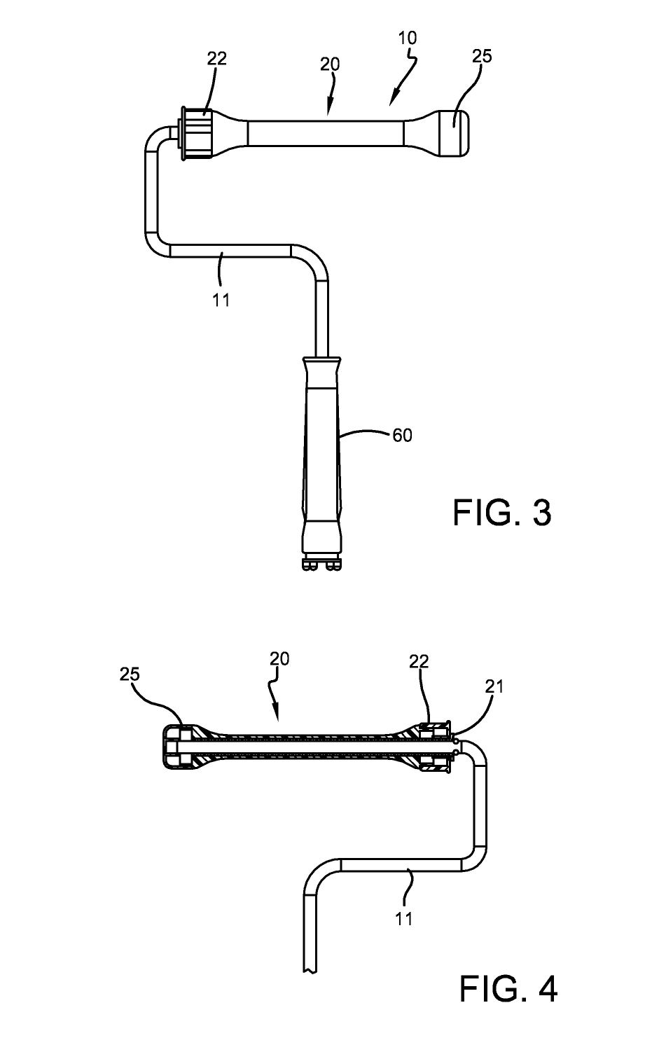

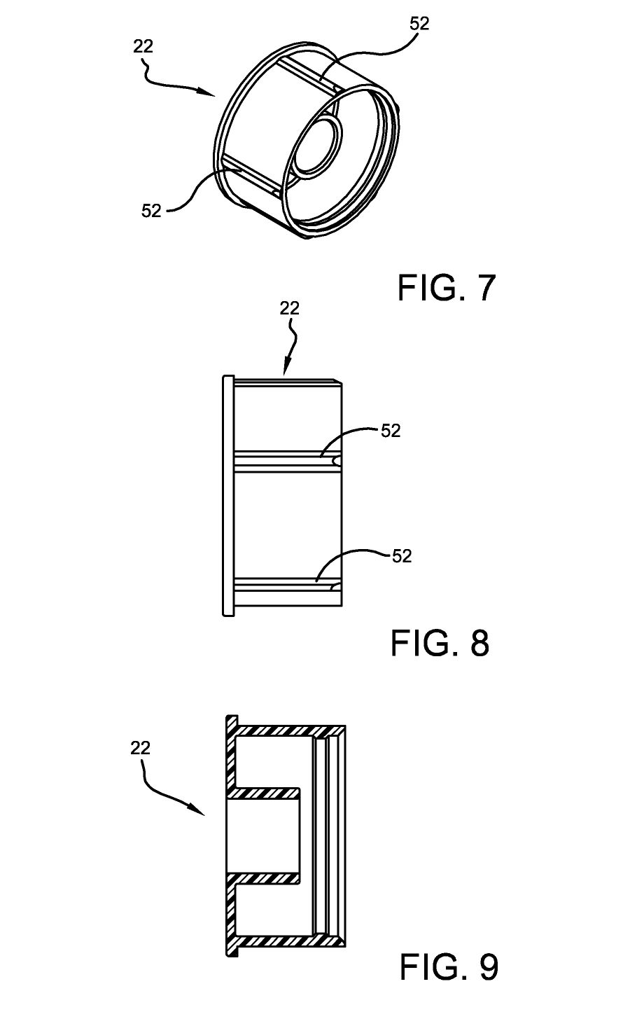

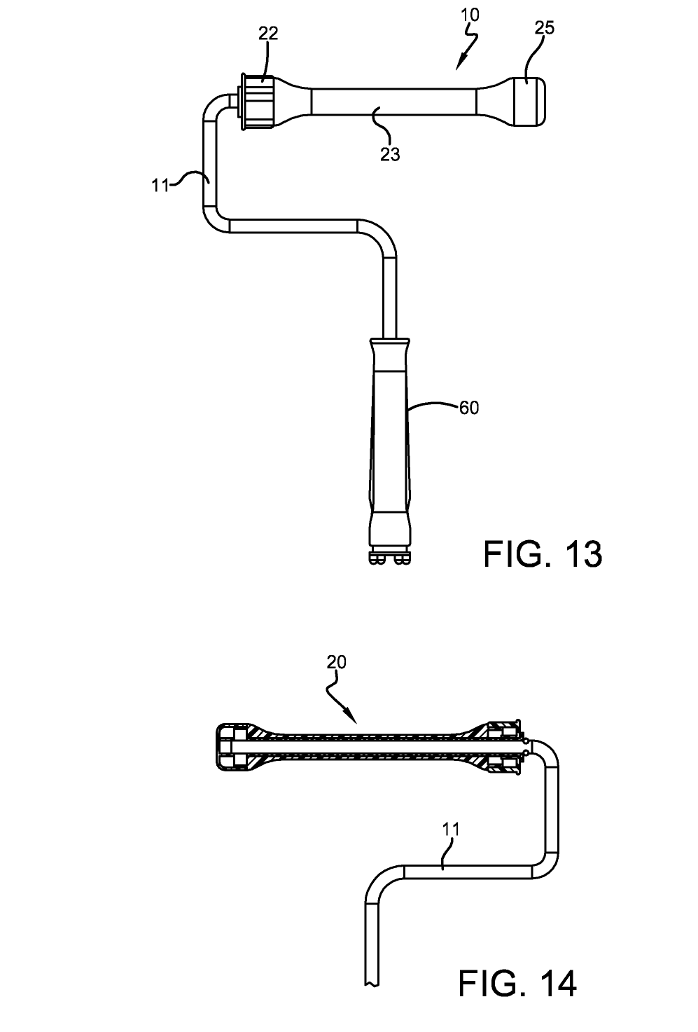

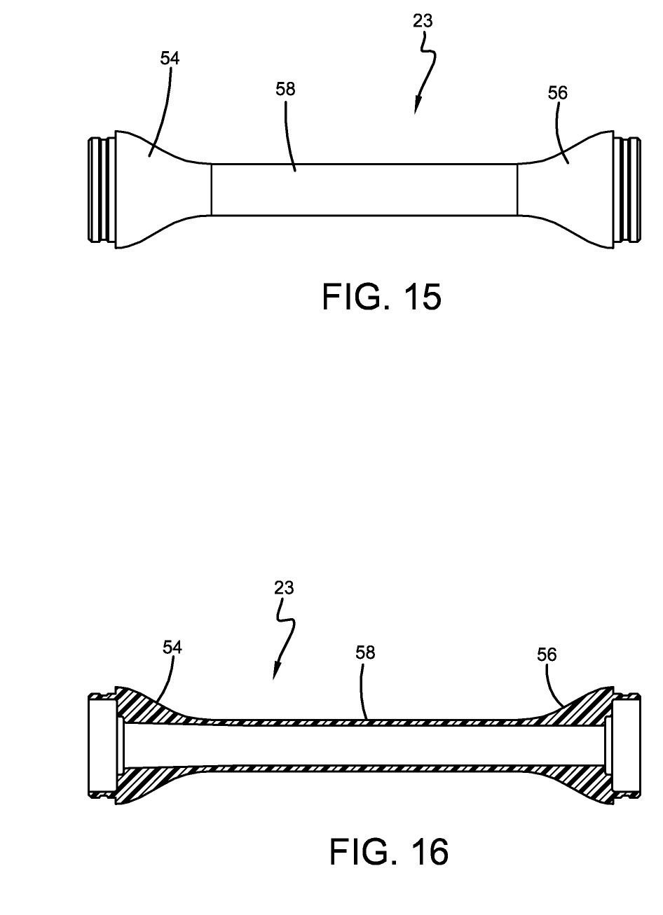

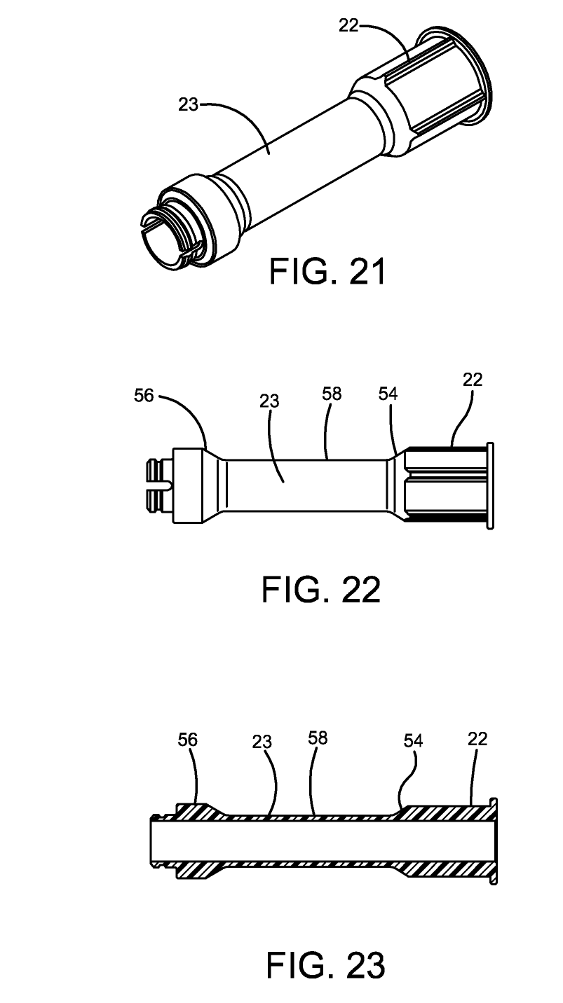

Referring to FIGS. 1-4, 7-9, 12-14, 17-19, and 21-23, the proximal bushing 22 may be substantially cylindrical in shape with a through bore sized to grip the bearing element's 21 outside diameter. The outside diameter of proximal bushing 22 may be sized to grip the inside diameter of an installed roller cover. The resulting grip may be tight enough to prevent the cover from working its way off the core support assembly 20 during use but also light enough so that the roller cover may be easily installed or removed for cleaning or disposal without the use of tools. In an alternate configuration the proximal bushing 22 may also have a lip formed at one end. The lip may be cylindrical in shape with the lip and the proximal bushing 22 being coaxial. The lip may be used as a feature to axially locate the roller cover during installation. In another alternate configuration the outside surface of the proximal bushing 22 may take the shape of a pentagon extruded in the axial direction. In this configuration the vertices of the pentagon form ridge lines which serve to grip the inside diameter of an installed roller cover. The resulting grip may be tight enough to prevent the cover from working its way off the core support assembly 20 during use but also light enough so that the roller cover may be easily installed or removed for cleaning or disposal without the use of tools. In another embodiment, the outer surface of the proximal bushing 55 comprises at least five ribs 52. These ribs 52 may be oriented axially and spaced equidistant from each other around the circumference of the proximal bushing 22. The proximal bushing's 22 inside diameter may include features which allow it to fixedly mate with the mid-portion 23 outside surface. The core support assembly 20 may be formed from plastic or any material chosen with the sound judgment of a person of skill in the art. In one embodiment the core support assembly 20 is made of an acetyl high-performance plastic. In one specific embodiment, the core support assembly 20 is made of Delrin®.

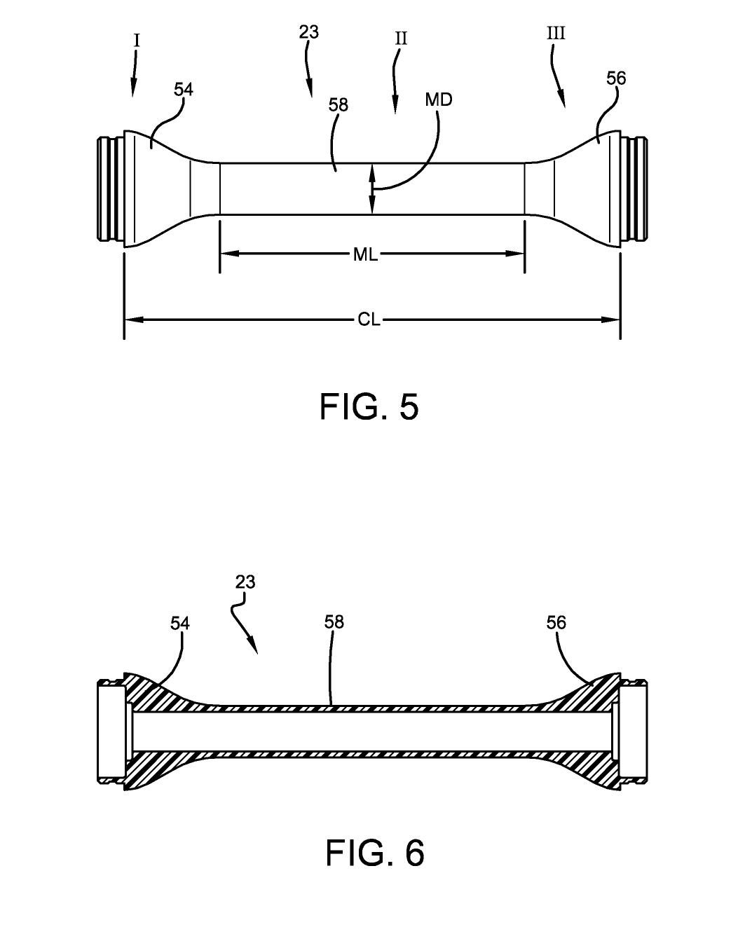

Referring to FIGS. 1 and 5, the mid-portion 23 may be a continuous piece consisting of three distinct sections which may be symmetric about the mid-portion's 23 longitudinal axis. Section I may be formed to mate with the proximal bushing 22 thus the outside surface of this section may have features which allow it to fixedly mate with the back bushing's 22 inside surface. Also the outside surface in section I may be similarly sized and shaped to cooperate with the proximal bushing 22 in gripping a paint roller cover. The outside surface of section II may be of a smaller dimensional size as compared to sections I or III. Sized in this manner, there may be clearance between the outside surface of section II and the inside diameter of an installed roller cover. Section III may be formed to mate with the distal bushing 25 thus the outside surface of this section may have features which allow it to fixedly mate with the front bushing's 25 inside surface. Also the outside surface in section 3 may be similarly sized and shaped as compared to the front bushing's 25 outside surface. Thus when the mid-portion 23 and the distal bushing 25 are installed on the frame 11 the adjoining outside surfaces is continuous. These outside surfaces of the mid-portion 23 and distal bushing 25 may be sized to grip the inside diameter of an installed paint roller cover. The resulting grip may be tight enough to prevent the cover from working its way off the core support assembly 20 during use but also light enough so that the roller cover may be easily installed or removed for cleaning or disposal without the use of tools. In an alternate configuration, these outside surfaces of the mid-portion 23 and distal bushing 25 may be sized for clearance with the roller cover and thus not grip the roller cover. In another alternate configuration the mid-portion 23 may be integral to the proximal bushing 22.

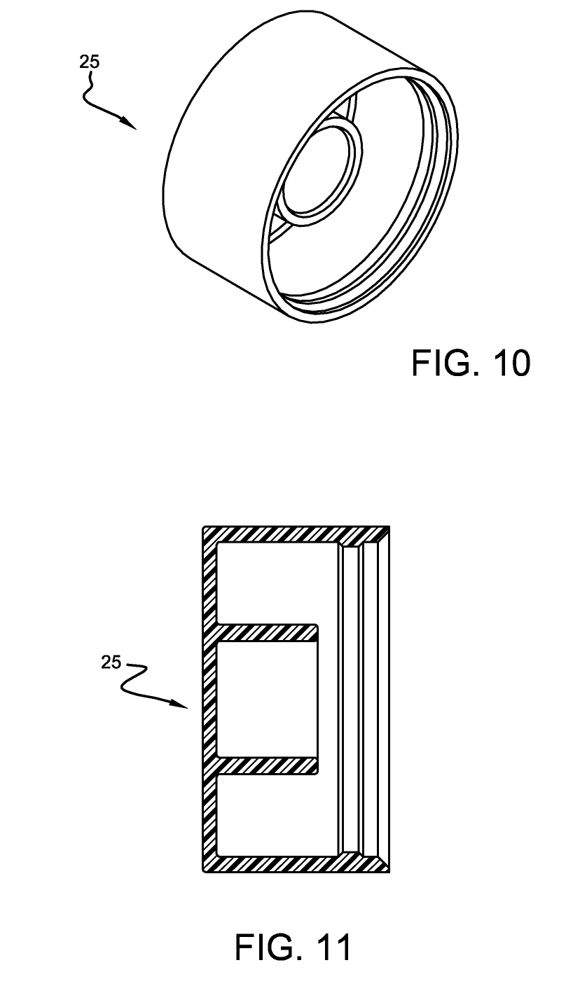

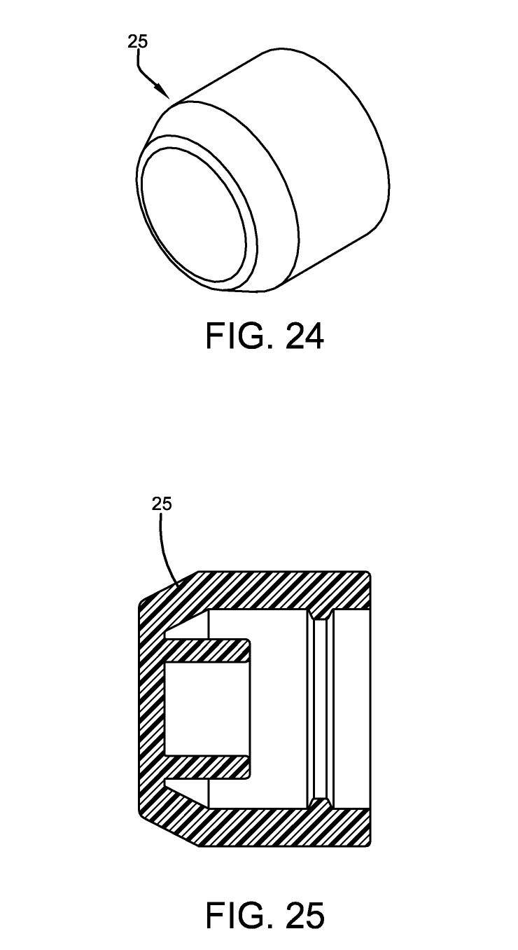

Referring to FIGS. 1-4, 10-14, 17-19 and 24-25, the distal bushing 25 may be a continuous piece consisting of two distinct sections which may be symmetric about the distal bushing's 25 longitudinal axis. The first section may be cylindrical in shape and may be formed to mate with the mid-portion 23. Thus the inside surface of this section may have features which allow it to fixedly mate with the dog bone member's 23 outside surface. Also the outside surface in the first section may be similarly sized as the outside surface of the mating section of the mid-portion 23. Thus when the mid-portion 23 and the distal bushing 25 are installed on the frame 11 the adjoining outside surfaces are continuous. The second section may be formed in a frustro-conical shape. Thus the tapered end of the distal bushing 25 may aid in installing a roller cover over the core support assembly 20. The distal bushing 25 may have a bore of a fixed depth. The bore opening may appear on the end of first section that mates with the mid-portion 23. The bore may be co-axial with the distal bushing's 25 longitudinal axis. The bore's depth may be such when the distal bushing 25 is installed on the mid-portion 23, the distal end of the shaft 13 does not interfere with the distal bushing 25. In one embodiment, the distal bushing 25 has an outer diameter that is smaller at its distal end than at its proximal end. This makes it easier to fit the roller cover 50 over the distal bushing 25. In an alternate configuration, the bearing element 21 and rear washer 14 may be integral.

With reference now to FIG. 5, the mid-portion 23 may have a length CL and the middle portion 58 may have a length ML. In one embodiment, the ratio of the length ML to the length CL, ML/CL, is at least 0.5. In another embodiment, the ratio of the length ML to the length CL, ML/CL, is at least 0.75. The mid-portion 23 may have a diameter MD and the proximal bushing 22 may have a diameter PD. In one embodiment, the ratio of the diameter MD to the diameter PD, MD/PD, is not greater than 0.75. In another embodiment, the ratio of the diameter MD to the diameter PD, MD/PD, is not greater than 0.6.

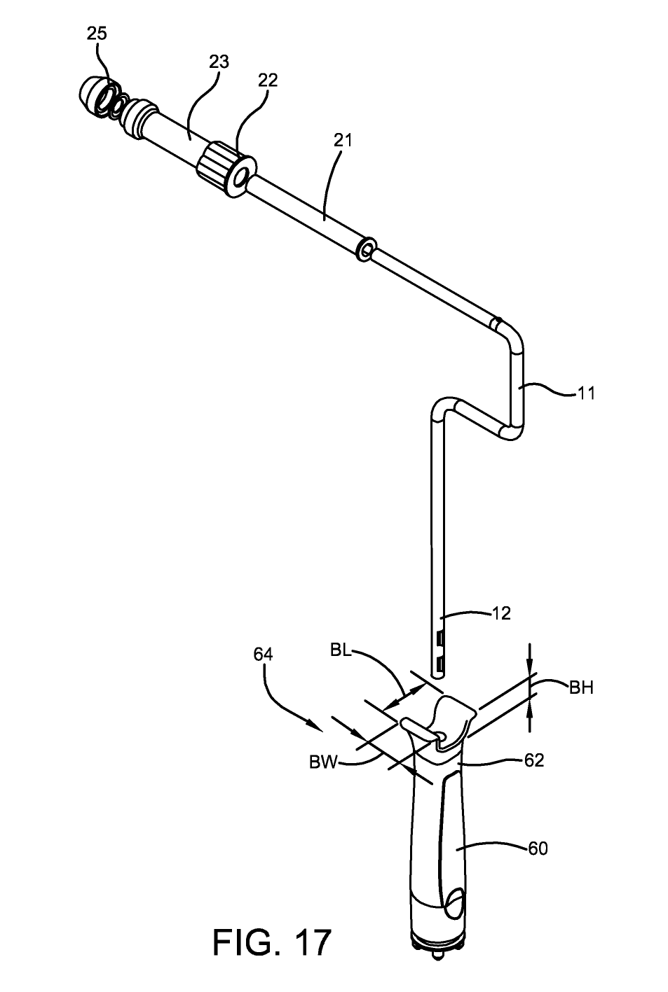

With reference now to FIG. 17, a roller handle 60 may be installed on the handle portion 12 of the frame 11. The handle 60 may have a first end 62 that is attachable to the frame 11. The first end 62 may have a bucket hook 64 having a length BL, a width BW, and a height BH. The bucket hook 64 is used, as known to those of skill in the art, to temporarily position the paint roller support 10 and roller cover 50 on the edge of a bucket (not shown). In one embodiment, the ratio of the length to the height BL/BH is at least 1.5. In another embodiment, the ratio of the length to the height BL/BH is at least 2.0. In yet another embodiment, the length BL is at least 0.75 inches. In another embodiment, the length BL is approximately 1.0 inch. In another embodiment, the width BW is at least 0.75 inches. These embodiments for the bucket hook 64 provide for better performance over bucket hooks currently known.

With reference now to all the FIGURES, in one use of the paint roller support apparatus a roller handle 60 may be installed on the handle portion 12 of the frame 11. The rear washer 14 and then the bearing element 21 may be slide over the shaft section 13. Next the proximal bushing 22 may be pressed over the bearing element until the ends of the bearing element 21 and the proximal bushing 22 are aligned. The mid-portion 23 may then pressed over the bearing element 21 until the mid-portion 23 mates with the proximal bushing 22. The front washer 24 may be slide over the shaft 13 and the distal bushing 25 may be mated to the mid-portion 23. To complete the paint roller, a paint roller cover 50 may be pressed over the core support assembly 20. The paint roller cover 50 then may be treated with a desired coating such as paint, stain, or the like. The paint roller may then be used to apply the desired coating to a selected surface.

With continuing reference to all the FIGURES, in a second use of the paint roller support apparatus a roller handle may be installed on the handle portion 12 of the frame 11. The bearing element 21 with an integral rear washer may be slide over the shaft section 13. Next an integral proximal bushing 22 and mid-portion 23 may be pressed over the bearing element until the ends of the bearing element 21 and the proximal bushing 22 and mid-portion 23 are aligned. The front washer 24 may be slide over the shaft 13 and the distal bushing 25 may be mated to the proximal bushing 22 and mid-portion 23. To complete the paint roller, a paint roller cover 50 may be pressed over the core support assembly 20. The paint roller cover then may be treated with a desired coating such as paint, stain, or the like. The paint roller 50 may then be used to apply the desired coating to a selected surface.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof

Having thus described the invention, it is now claimed:

1. A paint roller support comprising:
a frame;
a shaft having a proximal end connected to the frame and a distal free end;
a bearing element that is received over the shaft and that comprises a proximal end portion and a distal end portion; and,
a core support assembly suitable to receive an associated paint roller cover having a proximal end and a distal end, the core support assembly comprising:
a proximal bushing that is received over the proximal end portion of the bearing element and that has an outer surface suitable to contact an inner surface of the proximal end of the associated paint roller cover to support the associated paint roller cover to the core support assembly;
a distal bushing that is received over the distal end portion of the bearing element and that has an outer surface suitable to contact an inner surface of the distal end of the associated paint roller cover to support the associated paint roller cover to the core support assembly; and,
a mid-portion comprising: a proximal end that contacts the proximal bushing and that has a frustoconical shape; a distal end that contacts the distal bushing and that has a frustoconical shape; and, a middle portion having a cylindrical shape with a substantially constant outer diameter.

2. The paint roller support of claim 1 wherein the outer surface of the proximal bushing has the shape of a pentagon extruded in the axial direction.

3. The paint roller support of claim 1 wherein the outer surface of the proximal bushing comprises at least five ribs.

4. The paint roller support of claim 1 wherein the bearing element is one piece.

5. The paint roller support of claim 1 wherein:
the mid-portion of the core support assembly has a length CL and the middle portion has a length ML; and,
a ratio of the length ML to the length CL, ML/CL is at least 0.5.

6. The paint roller support of claim 5 wherein a ratio of the length ML to the length CL, ML/CL is at least 0.75.

7. The paint roller support of claim 1 wherein:
the mid-portion of the core support assembly has a diameter MD and the proximal bushing has a diameter PD; and,
a ratio of the diameter MD to the diameter PD, MD/PD, is not greater than 0.75.

8. The paint roller support of claim 1 wherein the ratio of the diameter MD to the diameter PD, MD/PD, is not greater than 0.6.

9. The paint roller support of claim 1 wherein the frame and shaft are made of aluminum and the core support assembly is made of an acetyl high-performance plastic.

10. The paint roller support of claim 1 wherein the distal bushing has an outer diameter that is smaller at its distal end than at its proximal end.

11. A paint roller support comprising:
a frame;
a shaft having a proximal end connected to the frame and a distal free end;
a bearing element that is at least 3.0 inches long and that comprises a proximal end that is received over the proximal end of the shaft and a distal end that is received over the distal end of the shaft; and,
a core support assembly suitable to receive an associated paint roller cover having a proximal end and a distal end, the core support assembly comprising:
a proximal bushing that is received over the proximal end of the bearing element and that has an outer surface suitable to contact an inner surface of the proximal end of the associated paint roller cover to support the associated paint roller cover to the core support assembly;
a distal bushing that is received over the distal end of the bearing element and that has an outer surface suitable to contact an inner surface of the distal end of the associated paint roller cover to support the associated paint roller cover to the core support assembly; and,
a mid-portion comprising: a proximal end that contacts the proximal bushing and;
a distal end that contacts the distal bushing; and, a middle portion.

12. The paint roller support of claim 11 wherein the core support assembly is less than 4.0 inches long.

13. The paint roller support of claim 11 wherein the bearing element is at least 8.0 inches long and the core support assembly is at least 8.0 inches long.

14. The paint roller support of claim 11 wherein the bearing element does not rotate with respect to the shaft and the core support assembly rotates with respect to the bearing element.

15. The paint roller support of claim 11 wherein the bearing element rotates with respect to the shaft and the core support assembly does not rotate with respect to the bearing element.

16. A paint roller support comprising:
a frame having a first end and a second end;
a shaft having a proximal end connected to the first end of the frame and a distal free end;
a core support assembly that is received over the shaft and that has an outer surface suitable to contact an inner surface of an associated paint roller cover to support the associated paint roller cover to the core support assembly;
a handle having a first end that is attachable to the second end of the frame, the first end of the handle comprising a bucket hook having a length BL, a width BW, and a height BH; and,
wherein a ratio of the length to the height BL/BH is at least 1.5.

17. The paint roller support of claim 16 wherein the ratio of the length to the height BL/BH is at least 2.0.

18. The paint roller support of claim 17 wherein the length BL is at least 0.75 inches.

19. The paint roller support of claim 18 wherein the length BL is approximately 1.0 inch.

20. The paint roller support of claim 19 wherein the width BW is at least 0.75 inches.
